(19) United States
(12) Patent Application Publication
(10) Pub. No.: US 2016/0059314 A1
(43) Pub. Date: Mar. 3, 2016

(54) METHOD FOR IMPROVED MATERIAL PROPERTIES IN ADDITIVE MANUFACTURING

(71) Applicant: Arcam AB, Moelndal (SE)

(72) Inventors: Ulric Ljungblad, Moelndal (SE); Ulf Ackelid, Goeteborg (SE); Lars Loevgren, Haellingsjoe (SE)

(21) Appl. No.: 14/750,812

(22) Filed: Jun. 25, 2015

Related U.S. Application Data
(60) Provisional application No. 62/045,350, filed on Sep. 3, 2014.

(51) Int. Cl. B22F 3/24; B22F 3/105

(52) U.S. Cl. CPC B22F 3/24; B22F 3/1055; B22F 2003/245; B33Y 10/00

(57) ABSTRACT

A method for forming at a three-dimensional article through successively depositing individual layers of powder material that are fused together with at least one energy beam so as to form the article, the method comprising the steps of: generating a model of the three-dimensional article; applying a first powder layer on a work table; directing the at least one energy beam from at least one energy beam source over the work table causing the first powder layer to fuse in first selected locations according to the model to form a first cross section of the three-dimensional article; introducing a predetermined surface topography on the first cross section for reducing thickness variations and or increasing the powder packing density in a powder layer provided on top of the first cross section.

### CROSS-REFERENCE TO RELATED APPLICATIONS

This application claims priority to and the benefit of U.S. Provisional Patent Application Ser. No. 62/045,350, filed Sep. 3, 2014; the contents of which as are hereby incorporated by reference in their entirety.

### BACKGROUND

1. Related Field

Various embodiments of the present invention relate to methods, apparatuses, and computer program products for additive manufacturing of three-dimensional articles.

2. Description of Related Art

Freeform fabrication or additive manufacturing is a method for forming three-dimensional articles through successive fusion of chosen parts of powder layers applied to a worktable. A method and apparatus according to this technique is disclosed in US 2009/0152771.

Such an apparatus may comprise a work table on which the three-dimensional article is to be formed, a powder dispenser, arranged to lay down a thin layer of powder on the work table for the formation of a powder bed, an energy beam source for delivering an energy beam spot to the powder whereby fusion of the powder takes place, elements for control of the energy beam spot over the powder bed for the formation of a cross section of the three-dimensional article through fusion of parts of the powder bed, and a controlling computer, in which information is stored concerning consecutive cross sections of the three-dimensional article. A three-dimensional article is formed through consecutive fusions of consecutively formed cross sections of powder layers, successively laid down by the powder dispenser.

Material properties of the final 3D-article depend inter alia on the capability of providing a powder layer with homogenous thickness and high packing density repeatedly. A heterogenous thickness of one or several powder layers and/or one or several powder layers which comprises low packing density may result in porous final articles and/or articles with undesirable microstructures which is a problem in a powder based additive manufacturing.

### BRIEF SUMMARY

Having this background, an object of the invention is to provide methods and associated systems that enable production of three-dimensional articles by freeform fabrication or additive manufacturing, wherein the powder layer thickness homogeneity is improved. The above-mentioned object is achieved by the features according to the claims contained herein.

In a first aspect of the invention it is provided a method for forming at a three-dimensional article through successively depositing individual layers of powder material that are fused together with at least one energy beam so as to form the article, the method comprising the steps of: generating a model of the three-dimensional article; applying a first powder layer on a work table; directing the at least one energy beam from at least one energy beam source over the work table causing the first powder layer to fuse in first selected locations according to the model to form a first cross section of the three-dimensional article; introducing a predetermined surface topography on the first cross section for reducing thickness variations and/or increasing packing density in a powder layer provided on top of the first cross section.

An exemplary and non-limiting advantage of the present invention is that three dimensional components with predictable microstructures throughout the components may be manufactured. Other material properties such as tensile strength and ductility may also be more predictable and may be manufacture with a higher repeatability.

The topography may be generated by remelting the top surface, generated while melting the powder material and/or by elevating the surface temperature to a temperature high enough for softening the top surface but below the melting point.

It is advantageous that the surface topography may not only be created while melting the powder material but also later on so that corrections of the topography of the melted surface may be done.

In another example embodiment according to the present invention the predetermined surface topography is having a spatial frequency and amplitude which is adapted to the powder particle size distribution. An exemplary and non-limiting advantage of this embodiment is that the amplitude and spatial frequency is adapted to the particular type of powder used in order to achieve the desired powder layer packing density and/or powder layer surface flatness.

In still another example embodiment a surface topography pattern in a first cross section of the three-dimensional article may be rotated with respect to the surface topography pattern in a second cross section of the three-dimensional article. An exemplary and non-limiting advantage of this embodiment is that any irregularity that may show up as a defect if overlaying the same pattern over and over again without rotation may be eliminated. Another means for eliminating defect generation may be to use different topography patterns for different layers of a single three dimensional article. Still another means for eliminating defects may be to rotate the hatch direction for fusing the powder material with respect to the hatch direction for creating the surface topography.

In another example embodiment of the present invention the topography pattern orientation is adapted to the powder application direction. This may be advantageous in cases different topography pattern direction with respect to a powder application direction may result in a different packing density and/or powder layer surface flatness. One may choose the topography pattern direction for achieving a given packing density and/or a given powder layer surface flatness.

In still another example embodiment multiple energy beam sources may be used, a first energy beam source for melting the powder material and a second energy beam source for creating a desired surface topography. The first and second energy beam sources may work simultaneously or after each other.

According to various embodiments, a program element is also provided. The program element is configured and arranged when executed on a computer to implement a method for verifying a deflection speed of an energy beam spot. The method comprises the steps of: generating a model of the three-dimensional article; applying a first powder layer on a work table; directing the at least one energy beam from at least one energy beam source over the work table causing the first powder layer to fuse in first selected locations according to the model to form a first cross section of the three-dimensional article; and generating a predetermined surface topography on the first cross section, the predetermined surface topography being configured to at least one of reduce thickness variations or increase packing density in a powder layer provided on top of the first cross section.

According to various embodiments, a non-transitory computer program product comprising at least one computer-readable storage medium having computer-readable program code portions embodied therein may be provided. The computer-readable code portions comprise: an executable portion configured for generating a model of the three-dimensional article; an executable portion configured for applying a first powder layer on a work table; an executable portion configured for directing the at least one energy beam from at least one energy beam source over the work table causing the first powder layer to fuse in first selected locations according to the model to form a first cross section of the three-dimensional article; and an executable portion configured for generating or introducing a predetermined surface topography on the first cross section for at least one of reducing thickness variations or increasing packing density in a powder layer provided on top of the first cross section.

### BRIEF DESCRIPTION OF THE SEVERAL VIEWS OF THE DRAWINGS

Having thus described the invention in general terms, reference will now be made to the accompanying drawings, which are not necessarily drawn to scale, and wherein:

FIG. 1 depicts a view from above of a top surface of a powder layer with an enlarged view of a small portion of the powder layer in an additive manufacturing apparatus;

FIG. 2 depicts schematically a cross section of the powder layer along line A-A in FIG. 1;

FIG. 3 depicts an apparatus in which the present invention may be implemented;

FIG. 4 depicts schematically a flowchart of an example embodiment of the method according to the present invention;

FIG. 5 is a block diagram of an exemplary system 1020 according to various embodiments;

FIG. 6A is a schematic block diagram of a server 1200 according to various embodiments; and

FIG. 6B is a schematic block diagram of an exemplary mobile device 1300 according to various embodiments.

### DETAILED DESCRIPTION OF VARIOUS EMBODIMENTS

Various embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein. Rather, these embodiments are provided so that this disclosure will satisfy applicable legal requirements. Unless otherwise defined, all technical and scientific terms used herein have the same meaning as commonly known and understood by one of ordinary skill in the art to which the invention relates. The term “or” is used herein in both the alternative and conjunctive sense, unless otherwise indicated. Like numbers refer to like elements throughout.

Still further, to facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

The term “three-dimensional structures” and the like as used herein refer generally to intended or actually fabricated three-dimensional configurations (e.g., of structural material or materials) that are intended to be used for a particular purpose. Such structures, etc. may, for example, be designed with the aid of a three-dimensional CAD system.

The term “electron beam” as used herein in various embodiments refers to any charged particle beam. The sources of charged particle beam can include an electron gun, a linear accelerator and so on.

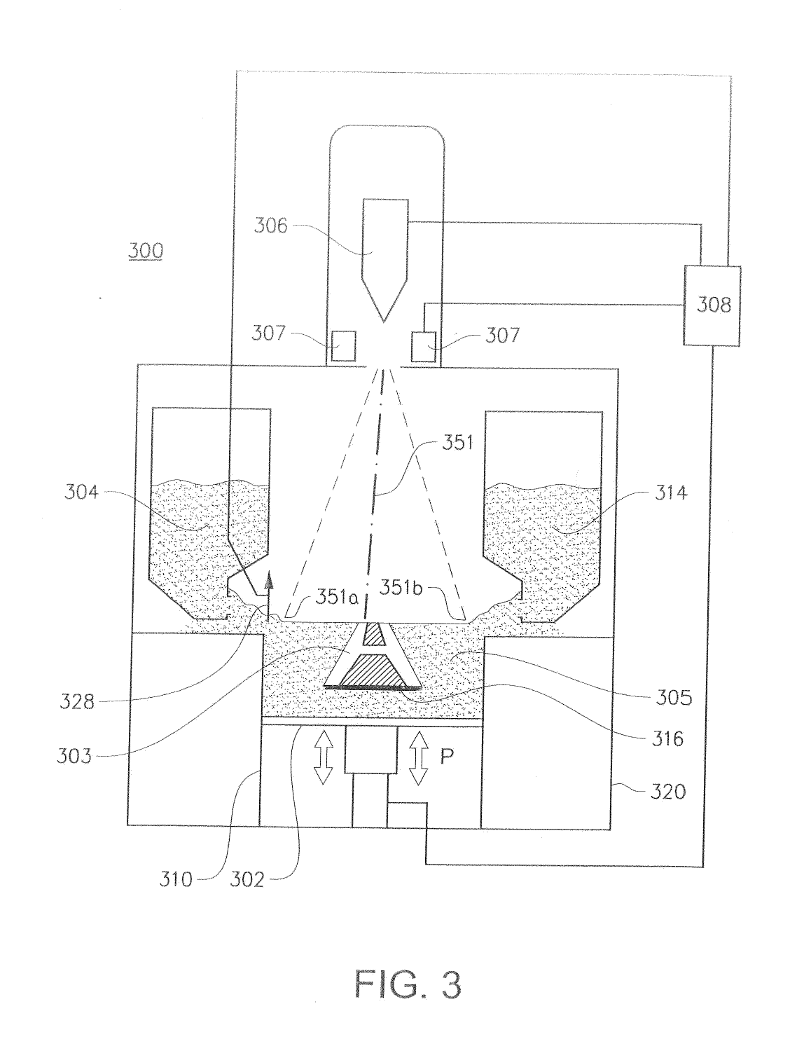

FIG. 3 depicts an example embodiment of a freeform fabrication or additive manufacturing apparatus 300 according to prior art in which the present invention may be implemented. The apparatus 300 comprises an electron source 306; two powder hoppers 304, 314; a start plate 316; a build tank 310; a powder distributor 328; a build platform 302; a vacuum chamber 320, a beam deflection unit 307 and a control unit 308. FIG. 3 discloses only one beam source for sake of simplicity. Of course, any number of beam sources may be used.

The vacuum chamber 320 is capable of maintaining a vacuum environment by means of or via a vacuum system, which system may comprise a turbo molecular pump, a scroll pump, an ion pump and one or more valves which are well known to a skilled person in the art and therefore need no further explanation in this context. The vacuum system may be controlled by the control unit 308. In an alternative embodiment the build tank may be provided in an enclosable chamber provided with ambient air and atmosphere pressure. In still another example embodiment the build chamber may be provided in open air.

The electron beam source 306 is generating an electron beam, which may be used for melting or fusing together powder material 305 provided on the work table. At least a portion of the electron beam source 306 may be provided in the vacuum chamber 320. The control unit 308 may be used for controlling and managing the electron beam emitted from the electron beam source 306. The electron beam 351 may be deflected between at least a first extreme position 351a and at least a second extreme position 351b.

At least one focusing coil, at least one deflection coil and an electron beam power supply may be electrically connected to the control unit 308. The beam deflection unit 307 may comprise the at least one focusing coil, the at least one deflection coil and optionally at least one astigmatism coil. In an example embodiment of the invention the electron beam source may generate a focusable electron beam with an accelerating voltage of about 60 kV and with a beam power in the range of 0-3 kW. The pressure in the vacuum chamber may be in the range of 10⁻³-10⁻⁶ mBar when building the three-dimensional article by fusing the powder layer by layer with the energy beam source 306.

Instead of melting the powder material with an electron beam, one or more laser beams and/or electron beams may be used. Each laser beam may normally be deflected by one or more movable mirrors provided in the laser beam path between the laser beam source and the work table onto which the powder material is arranged which is to be fused by the laser beam. The control unit 308 may manage the deflection of the mirrors so as to steer the laser beam to a predetermined position on the work table.

The powder hoppers 304, 314 may comprise the powder material to be provided on the start plate 316 in the build tank 310. The powder material may for instance be pure metals or metal alloys such as titanium, titanium alloys, aluminum, aluminum alloys, stainless steel, Co—Cr—W alloy, etc. Instead of two powder hoppers, one powder hopper may be used. Other designs and/or mechanism for of the powder supply may be used, for instance a powder tank with a height-adjustable floor.

The powder distributor 328 may be arranged to lay down a thin layer of the powder material on the start plate 316. During a work cycle the build platform 302 will be lowered successively in relation to the energy beam source after each added layer of powder material. In order to make this movement possible, the build platform 302 is in one embodiment of the invention arranged movably in vertical direction, i.e., in the direction indicated by arrow P. This means that the build platform 302 may start in an initial position, in which a first powder material layer of necessary thickness has been laid down on the start plate 316. A first layer of powder material may be thicker than the other applied layers. The build platform may thereafter be lowered in connection with laying down a new powder material layer for the formation of a new cross section of a three-dimensional article. Means for lowering the build platform 302 may for instance be through a servo engine equipped with a gear, adjusting screws etc.

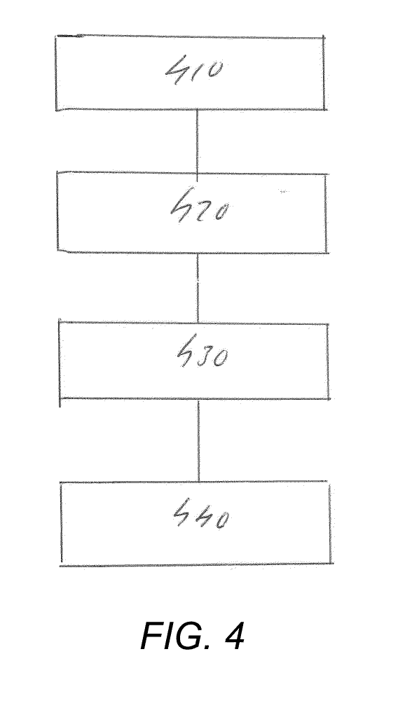

In FIG. 4 it is depicted a flow chart of an example embodiment of a method according to the present invention for forming a three-dimensional article through successive fusion of parts of a powder bed, which parts correspond to successive cross sections of the three-dimensional article.

The method comprising a first step 410 of generating a model of the three dimensional article. The model may be a computer model generated via a CAD (Computer Aided Design) tool. The three-dimensional articles which are to be built may be equal or different to each other.

In a second step 420 a first powder layer is provided on a work table. The work table may be the start plate 316, the build platform 302, a powder bed or a partially fused powder bed. The powder may be distributed evenly over the worktable according to several methods. One way to distribute the powder is to collect material fallen down from the hopper 304, 314 by a rake system. The rake or powder distributor 328 may be moved over the build tank and thereby distributing the powder over the work table.

A distance between a lower part of the rake and the upper part of the start plate or previous powder layer determines the thickness of powder distributed over the work table. The powder layer thickness can easily be adjusted by adjusting the height of the build platform 302.

In a third step 430 at least one energy beam from at least one energy beam source is directed over the work table causing the first powder layer to fuse in first selected locations according to the model to form a first cross section of the three-dimensional article 303.

The first energy beam may be fusing a first article with parallel scan lines in a first direction and a second article with parallel scan lines in a second direction.

The first energy beam may be an electron beam or a laser beam. The beam is directed over the work table from instructions given by the control unit 308. In the control unit 308 instructions for how to control the beam source 306 for each layer of the three-dimensional article may be stored.

In a fourth step 440 a predetermined surface topography is introduced on the first cross section for reducing thickness variations and increasing packing density of the powder particles in a powder layer provided on top of the first cross section.

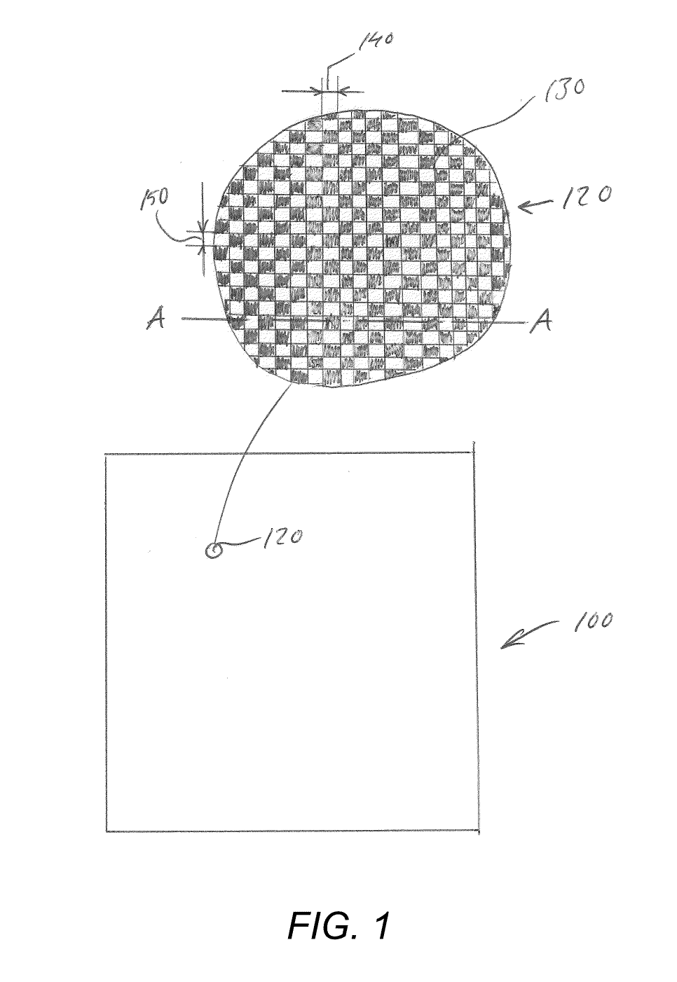

FIG. 1 depicts a view from above of a top surface 100 of a powder layer with an enlarged view 120 of a small portion of the powder layer in an additive manufacturing apparatus. In the enlarged view it is evident that the surface has a chessboard pattern. The dark sections represent a lower portion compared to the bright sections. A single square in the chessboard pattern has a width denoted by 140 and a length denoted by 150.

The chessboard pattern may be generated in the top surface by a remelting procedure. Alternatively the structure is already provided in the top surface when the powder material is melted. The width and length of the squares in the chessboard pattern may be adapted to the powder particle size distribution. In an example embodiment the width and length may be equal to the mean particle size in the particle size distribution. In another example embodiment the width and length is adapted to the largest size in the particle size distribution.

Instead of generating a chessboard pattern, where the black or white areas are indentations, on the top surface a pattern with circles, triangles, or any other type of geometric form may be generated. In an example embodiment the indentations are provided in a hexagonal pattern. The size of the individual geometrical forms in the pattern may be adapted to the particle size distribution in order to give as flat top surface and as high packing density as possible of a newly applied powder layer on top of the patterned surface. A thick powder layer may require another type of pattern compared to a thin powder layer in order to achieve the same flatness of its powder surfaces or packing density of the powder layer. Powder material from a first powder manufacturer may require a first type of pattern and a powder material from a second powder manufacturer may require a second type of pattern, wherein the first and second patterns are different in order to achieve a predetermined powder layer top surface flatness or packing density on top of the first and second pattern.

A first powder distribution speed may require a first type of pattern and a second powder distribution speed may require a second type of pattern, wherein the first and second patterns are different in order to achieve a predetermined powder layer top surface flatness or packing density on top of the first and second pattern.

Another parameter that may influence the optimal choice of pattern is the surface temperature of the surface on which the powder layer is to be applied.

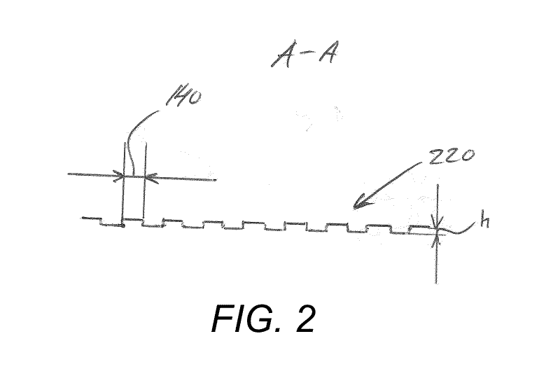

FIG. 2 depicts schematically a cross section of the powder layer along line A-A in FIG. 1. A predetermined spatial frequency of the topography of the top surface, together with predetermined amplitude of the topography may determine the top surface ability to generate a flat top surface of a newly applied powder layer for a predetermined particle size distribution. A height h, which is the difference in height between the lower white portions and the higher black portions in the exemplified chessboard pattern, is adapted to the powder particle size distribution. In an example embodiment the height, or amplitude, is set to the mean particle size in the particle size distribution. The value of h may, in an example embodiment, be 10-50% of the diameter of the mean particle size of the powder which is forming the powder layer. In another example embodiment the value of h may be 10-50% of the diameter of the largest particles in the particle size distribution which is used for formation of the powder layers.

In an example embodiment the surface topography may be generated while the cross section of the three-dimensional article is manufactured. In a first example embodiment the surface topography is generated directly while melting the powder. In an another example embodiment a first portion of the top surface is remelted while a second portion of the top surface of the three-dimensional article is still covered with non-melted powder.

In still another example embodiment the topography is generated after the full cross section of the three-dimensional article has been completed. The topography may for a first cross section of the three-dimensional article have a first orientation and for a second cross section have a second orientation. The angel between the first and second orientation may be an arbitrarily chosen integer value. The angle may also be stochastically chosen. Instead of rotating the topography pattern from one layer to another the same orientation may be chosen throughout the three-dimensional article.

The surface topography may not only be generated by remelting the top surface but also directly when melting the powder material. A surface topography may also be generated by elevating the top surface temperature to a temperature below the melting point in predetermined positions according to a desired pattern. The elevated temperature below the melting temperature may be sufficient for softening the surface and amending the surface topography locally.

The hatch direction for melting the powder material may be different compared to the hatch direction for generating the surface topography. In an example embodiment different topography patterns may be used for different layers in a three-dimensional article. If using multiple energy beam sources, a first energy beam source may be used for melting the powder material and a second energy beam source may be used for generating the surface topography.

In an example embodiment of the present invention the scan line direction may be rotated an angle α from one layer to another.

In an example embodiment of the present invention the scan lines in at least one layer of at least a first three-dimensional article may be fused with a first energy beam from a first energy beam source and at least one layer of at least a second three-dimensional article is fused with a second energy beam from a second energy beam source. More than one energy beam source may be used for fusing the scan lines.

By using more than one energy beam source the build temperature of the three-dimensional build may more easily be maintained compared to if just one beam source is used. The reason for this is that two beam may be at more locations simultaneously than just one beam. Increasing the number of beam sources will further ease the control of the build temperature. By using a plurality of energy beam sources a first energy beam source may be used for melting the powder material and a second energy beam source may be used for heating the powder material in order to keep the build temperature within a predetermined temperature range.

After a first layer is finished, i.e., the fusion of powder material for making a first layer of the three-dimensional article, a second powder layer is provided on the work table 316. The second powder layer is typically distributed according to the same manner as the previous layer. However, there might be alternative methods in the same additive manufacturing machine for distributing powder onto the work table. For instance, a first layer may be provided by means of or via a first powder distributor, a second layer may be provided by another powder distributor. The design of the powder distributor is automatically changed according to instructions from the control unit. A powder distributor in the form of a single rake system, i.e., where one rake is catching powder fallen down from both a left powder hopper 306 and a right powder hopper 307, the rake as such can change design.

In another example embodiment the surface topography after melting the powder layer may be amended by remelting the top surface or by elevating the surface temperature to a temperature below the melting point but high enough for softening the surface in order to amend its texture. The amended topography may comprise a predetermined pattern. In an example embodiment a first portion of a surface may be amended to be completely flat and a second portion of a surface may be amended to a desired topography.

In another aspect of the invention it is provided a program element configured and arranged when executed on a computer for reducing thickness variations and/or increasing packing density in a powder layer provided on top of the first cross section. The program element may specifically be configured to perform the steps of: generating a model of the three-dimensional article; applying a first powder layer on a work table; directing the at least one energy beam from at least one energy beam source over the work table causing the first powder layer to fuse in first selected locations according to the model to form a first cross section of the three-dimensional article; and generating a predetermined surface topography on the first cross section, the predetermined surface topography being configured to at least one of reduce thickness variations or increase packing density in a powder layer provided on top of the first cross section.

The program element may be installed in a computer readable storage medium. The computer readable storage medium may be any one of the control units described elsewhere herein or another and separate control unit, as may be desirable. The computer readable storage medium and the program element, which may comprise computer-readable program code portions embodied therein, may further be contained within a non-transitory computer program product. Further details regarding these features and configurations are provided, in turn, below.

As mentioned, various embodiments of the present invention may be implemented in various ways, including as non-transitory computer program products. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory VRAM, cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like, as have been described elsewhere herein. As such, embodiments of the present invention may take the form of an apparatus, system, computing device, computing entity, and/or the like executing instructions stored on a computer-readable storage medium to perform certain steps or operations. However, embodiments of the present invention may also take the form of an entirely hardware embodiment performing certain steps or operations.

Various embodiments are described below with reference to block diagrams and flowchart illustrations of apparatuses, methods, systems, and computer program products. It should be understood that each block of any of the block diagrams and flowchart illustrations, respectively, may be implemented in part by computer program instructions, e.g., as logical steps or operations executing on a processor in a computing system. These computer program instructions may be loaded onto a computer, such as a special purpose computer or other programmable data processing apparatus to produce a specifically-configured machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

Accordingly, blocks of the block diagrams and flowchart illustrations support various combinations for performing the specified functions, combinations of operations for performing the specified functions and program instructions for performing the specified functions. It should also be understood that each block of the block diagrams and flowchart illustrations, and combinations of blocks in the block diagrams and flowchart illustrations, could be implemented by special purpose hardware-based computer systems that perform the specified functions or operations, or combinations of special purpose hardware and computer instructions.

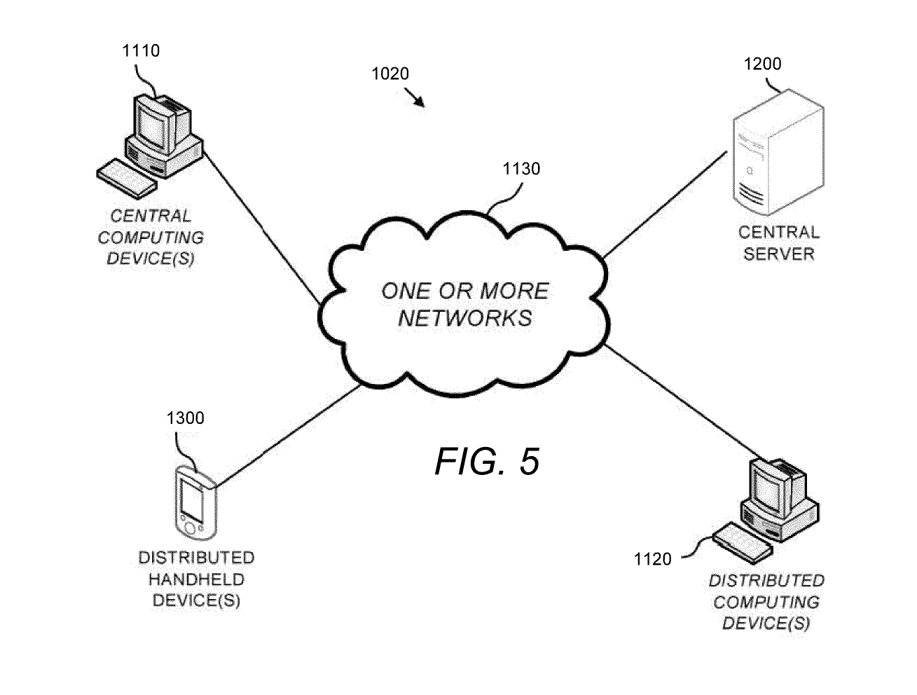

FIG. 5 is a block diagram of an exemplary system 1020 that can be used in conjunction with various embodiments of the present invention. In at least the illustrated embodiment, the system 1020 may include one or more central computing devices 1110, one or more distributed computing devices 1120, and one or more distributed handheld or mobile devices 1300, all configured in communication with a central server 1200 (or control unit) via one or more networks 1130. While FIG. 5 illustrates the various system entities as separate, standalone entities, the various embodiments are not limited to this particular architecture.

According to various embodiments of the present invention, the one or more networks 1130 may be capable of supporting communication in accordance with any one or more of a number of second-generation (2G), 2.5G, third-generation (3G), and/or fourth-generation (4G) mobile communication protocols, or the like. More particularly, the one or more networks 1130 may be capable of supporting communication in accordance with 2G wireless communication protocols IS-136 (TDMA), GSM, and IS-95 (CDMA). Also, for example, the one or more networks 1130 may be capable of supporting communication in accordance with 2.5G wireless communication protocols GPRS, Enhanced Data GSM Environment (EDGE), or the like. In addition, for example, the one or more networks 1130 may be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones). As yet another example, each of the components of the system 1020 may be configured to communicate with one another in accordance with techniques such as, for example, radio frequency (RF), Bluetooth™, infrared (IrDA), or any of a number of different wired or wireless networking techniques, including a wired or wireless Personal Area Network (“PAN”), Local Area Network (“LAN”), Metropolitan Area Network (“MAN”), Wide Area Network (“WAN”), or the like.

Although the device(s) 1110-1300 are illustrated in FIG. 5 as communicating with one another over the same network 1130, these devices may likewise communicate over multiple, separate networks.

According to one embodiment, in addition to receiving data from the server 1200, the distributed devices 1110, 1120, and/or 1300 may be further configured to collect and transmit data on their own. In various embodiments, the devices 1110, 1120, and/or 1300 may be capable of receiving data via one or more input units or devices, such as a keypad, touchpad, barcode scanner, radio frequency identification (RFID) reader, interface card (e.g., modem, etc.) or receiver. The devices 1110, 1120, and/or 1300 may further be capable of storing data to one or more volatile or non-volatile memory modules, and outputting the data via one or more output units or devices, for example, by displaying data to the user operating the device, or by transmitting data, for example over the one or more networks 1130.

In various embodiments, the server 1200 includes various systems for performing one or more functions in accordance with various embodiments of the present invention, including those more particularly shown and described herein. It should be understood, however, that the server 1200 might include a variety of alternative devices for performing one or more like functions, without departing from the spirit and scope of the present invention. For example, at least a portion of the server 1200, in certain embodiments, may be located on the distributed device(s) 1110, 1120, and/or the handheld or mobile device(s) 1300, as may be desirable for particular applications. As will be described in further detail below, in at least one embodiment, the handheld or mobile device(s) 1300 may contain one or more mobile applications 1330 which may be configured so as to provide a user interface for communication with the server 1200, all as will be likewise described in further detail below.

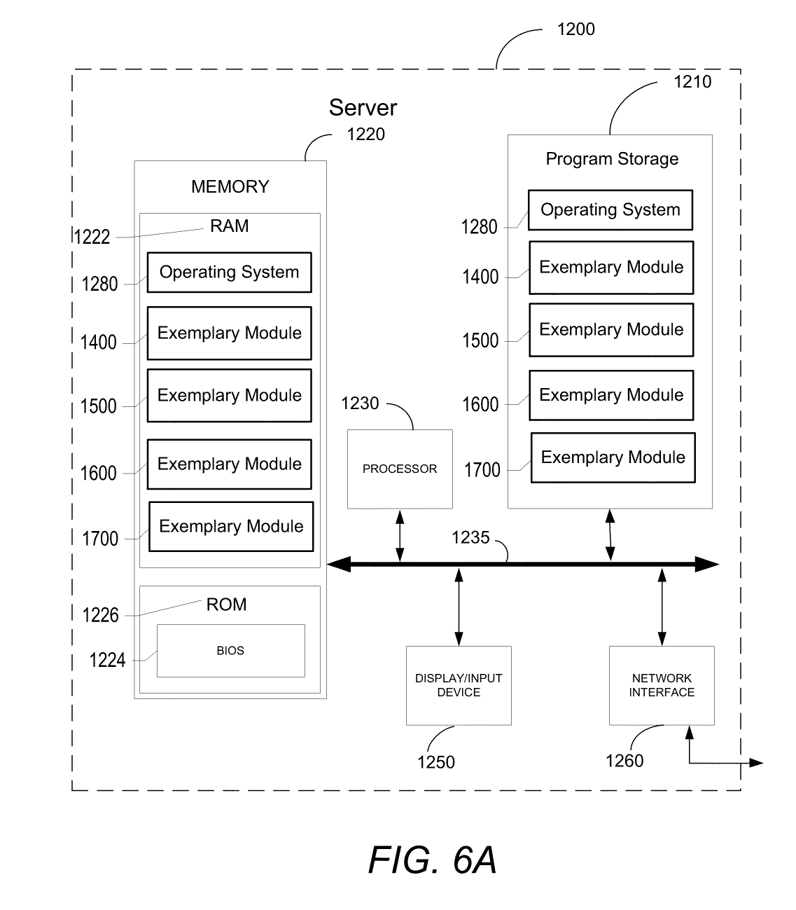

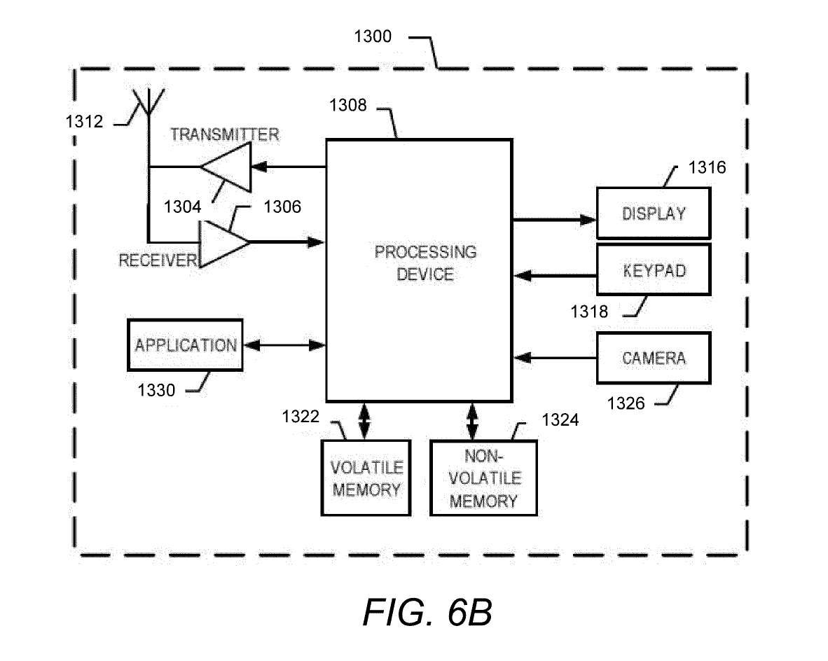

FIG. 6A is a schematic diagram of the server 1200 according to various embodiments. The server 1200 includes a processor 1230 that communicates with other elements within the server via a system interface or bus 1235. Also included in the server 1200 is a display/input device 1250 for receiving and displaying data. This display/input device 1250 may be, for example, a keyboard or pointing device that is used in combination with a monitor. The server 1200 further includes memory 1220, which typically includes both read only memory (ROM) 1226 and random access memory (RAM) 1222. The server's ROM 1226 is used to store a basic input/output system 1224 (BIOS), containing the basic routines that help to transfer information between elements within the server 1200. Various ROM and RAM configurations have been previously described herein.

In addition, the server 1200 includes at least one storage device or program storage 210, such as a hard disk drive, a floppy disk drive, a CD Rom drive, or optical disk drive, for storing information on various computer-readable media, such as a hard disk, a removable magnetic disk, or a CD-ROM disk. As will be appreciated by one of ordinary skill in the art, each of these storage devices 1210 are connected to the system bus 1235 by an appropriate interface. The storage devices 1210 and their associated computer-readable media provide nonvolatile storage for a personal computer. As will be appreciated by one of ordinary skill in the art, the computer-readable media described above could be replaced by any other type of computer-readable media known in the art. Such media include, for example, magnetic cassettes, flash memory cards, digital video disks, and Bernoulli cartridges.

Although not shown, according to an embodiment, the storage device 1210 and/or memory of the server 1200 may further provide the functions of a data storage device, which may store historical and/or current delivery data and delivery conditions that may be accessed by the server 1200. In this regard, the storage device 1210 may comprise one or more databases. The term “database” refers to a structured collection of records or data that is stored in a computer system, such as via a relational database, hierarchical database, or network database and as such, should not be construed in a limiting fashion.

A number of program modules (e.g., exemplary modules 1400-1700) comprising, for example, one or more computer-readable program code portions executable by the processor 1230, may be stored by the various storage devices 1210 and within RAM 1222. Such program modules may also include an operating system 1280. In these and other embodiments, the various modules 1400, 1500, 1600, 1700 control certain aspects of the operation of the server 1200 with the assistance of the processor 1230 and operating system 1280. In still other embodiments, it should be understood that one or more additional and/or alternative modules may also be provided, without departing from the scope and nature of the present invention.

In various embodiments, the program modules 1400, 1500, 1600, 1700 are executed by the server 1200 and are configured to generate one or more graphical user interfaces, reports, instructions, and/or notifications/alerts, all accessible and/or transmittable to various users of the system 1020. In certain embodiments, the user interfaces, reports, instructions, and/or notifications/alerts may be accessible via one or more networks 1130, which may include the Internet or other feasible communications network, as previously discussed.

In various embodiments, it should also be understood that one or more of the modules 1400, 1500, 1600, 1700 may be alternatively and/or additionally (e.g., in duplicate) stored locally on one or more of the devices 1110, 1120, and/or 1300 and may be executed by one or more processors of the same. According to various embodiments, the modules 1400, 1500, 1600, 1700 may send data to, receive data from, and utilize data contained in one or more databases, which may be comprised of one or more separate, linked and/or networked databases.

Also located within the server 1200 is a network interface 1260 for interfacing and communicating with other elements of the one or more networks 1130. It will be appreciated by one of ordinary skill in the art that one or more of the server 1200 components may be located geographically remotely from other server components. Furthermore, one or more of the server 1200 components may be combined, and/or additional components performing functions described herein may also be included in the server.

While the foregoing describes a single processor 1230, as one of ordinary skill in the art will recognize, the server 1200 may comprise multiple processors operating in conjunction with one another to perform the functionality described herein. In addition to the memory 1220, the processor 1230 can also be connected to at least one interface or other means for displaying, transmitting and/or receiving data, content or the like. In this regard, the interface(s) can include at least one communication interface or other means for transmitting and/or receiving data, content or the like, as well as at least one user interface that can include a display and/or a user input interface, as will be described in further detail below. The user input interface, in turn, can comprise any of a number of devices allowing the entity to receive data from a user, such as a keypad, a touch display, a joystick or other input device.

Still further, while reference is made to the “server” 1200, as one of ordinary skill in the art will recognize, embodiments of the present invention are not limited to traditionally defined server architectures. Still further, the system of embodiments of the present invention is not limited to a single server, or similar network entity or mainframe computer system. Other similar architectures including one or more network entities operating in conjunction with one another to provide the functionality described herein may likewise be used without departing from the spirit and scope of embodiments of the present invention. For example, a mesh network of two or more personal computers (PCs), similar electronic devices, or handheld portable devices, collaborating with one another to provide the functionality described herein in association with the server 1200 may likewise be used without departing from the spirit and scope of embodiments of the present invention.

According to various embodiments, many individual steps of a process may or may not be carried out utilizing the computer systems and/or servers described herein, and the degree of computer implementation may vary, as may be desirable and/or beneficial for one or more particular applications.

FIG. 6B provides an illustrative schematic representative of a mobile device 1300 that can be used in conjunction with various embodiments of the present invention. Mobile devices 1300 can be operated by various parties. As shown in FIG. 6B, a mobile device 1300 may include an antenna 1312, a transmitter 1304 (e.g., radio), a receiver 1306 (e.g., radio), and a processing element 1308 that provides signals to and receives signals from the transmitter 1304 and receiver 1306, respectively.

The signals provided to and received from the transmitter 1304 and the receiver 1306, respectively, may include signaling data in accordance with an air interface standard of applicable wireless systems to communicate with various entities, such as the server 1200, the distributed devices 1110, 1120, and/or the like. In this regard, the mobile device 1300 may be capable of operating with one or more air interface standards, communication protocols, modulation types, and access types. More particularly, the mobile device 1300 may operate in accordance with any of a number of wireless communication standards and protocols. In a particular embodiment, the mobile device 1300 may operate in accordance with multiple wireless communication standards and protocols, such as GPRS, UMTS, CDMA2000, 1×RTT, WCDMA, TD-SCDMA, LTE, E-UTRAN, EVDO, HSPA, HSDPA, Wi-Fi, WiMAX, UWB, IR protocols, Bluetooth protocols, USB protocols, and/or any other wireless protocol.

Via these communication standards and protocols, the mobile device 1300 may according to various embodiments communicate with various other entities using concepts such as Unstructured Supplementary Service data (USSD), Short Message Service (SMS), Multimedia Messaging Service (MMS), Dual-Tone Multi-Frequency Signaling (DTMF), and/or Subscriber Identity Module Dialer (SIM dialer). The mobile device 1300 can also download changes, add-ons, and updates, for instance, to its firmware, software (e.g., including executable instructions, applications, program modules), and operating system.

According to one embodiment, the mobile device 1300 may include a location determining device and/or functionality. For example, the mobile device 1300 may include a GPS module adapted to acquire, for example, latitude, longitude, altitude, geocode, course, and/or speed data. In one embodiment, the GPS module acquires data, sometimes known as ephemeris data, by identifying the number of satellites in view and the relative positions of those satellites.

The mobile device 1300 may also comprise a user interface (that can include a display 1316 coupled to a processing element 1308) and/or a user input interface (coupled to a processing element 308). The user input interface can comprise any of a number of devices allowing the mobile device 1300 to receive data, such as a keypad 1318 (hard or soft), a touch display, voice or motion interfaces, or other input device. In embodiments including a keypad 1318, the keypad can include (or cause display of) the conventional numeric (0-9) and related keys (#, *), and other keys used for operating the mobile device 1300 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The mobile device 1300 can also include volatile storage or memory 1322 and/or non-volatile storage or memory 1324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database mapping systems, data, applications, programs, program modules, scripts, source code, object code, byte code, compiled code, interpreted code, machine code, executable instructions, and/or the like to implement the functions of the mobile device 1300.

The mobile device 1300 may also include one or more of a camera 1326 and a mobile application 1330. The camera 1326 may be configured according to various embodiments as an additional and/or alternative data collection feature, whereby one or more items may be read, stored, and/or transmitted by the mobile device 1300 via the camera. The mobile application 1330 may further provide a feature via which various tasks may be performed with the mobile device 1300. Various configurations may be provided, as may be desirable for one or more users of the mobile device 1300 and the system 1020 as a whole.

The invention is not limited to the above-described embodiments and many modifications are possible within the scope of the following claims. Such modifications may, for example, involve using a different source of energy beam than the exemplified electron beam such as a laser beam. Other materials than metallic powder may be used, such as the non-limiting examples of: electrically conductive polymers and powder of electrically conductive ceramics. A shutter may be arranged to close the electron beam column when opening the vacuum chamber 20. The shutter is opened when the vacuum chamber 20 is closed.

Indeed, a person of ordinary skill in the art would be able to use the information contained in the preceding text to modify various embodiments of the invention in ways that are not literally described, but are nevertheless encompassed by the attached claims, for they accomplish substantially the same functions to reach substantially the same results. Therefore, it is to be understood that the invention is not limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method for forming at a three-dimensional article through successively depositing individual layers of powder material that are fused together with at least one energy beam so as to form the article, said method comprising the steps of:
generating a model of said three-dimensional article;
applying a first powder layer on a work table;
directing said at least one energy beam from at least one energy beam source over said work table causing said first powder layer to fuse in first selected locations according to said model to form a first cross section of said three-dimensional article; and
generating a predetermined surface topography on said first cross section for at least one of reducing thickness variations or increasing packing density in a powder layer provided on top of said first cross section.

2. The method according to claim 1, wherein said surface topography is generated by remelting said first cross section.

3. The method according to claim 1, wherein said generation of said surface topography on said first cross section is started to be introduced while said first cross section is created.

4. The method according to claim 1, wherein said generation of said surface topography on said first cross section is started to be introduced only after having finished said first cross section.

5. The method according to claim 1, wherein said predetermined surface topography has a spatial frequency and amplitude which is adapted to the powder particle size distribution.

6. The method according to claim 1, wherein said surface topography is at least one of a chess board pattern or a hexagonal pattern.

7. The method according to claim 1, wherein a pattern of said surface topography in a first cross section is rotated with respect to a pattern of said surface topography in a second cross section.

8. The method according to claim 7, wherein said pattern is identical throughout the three-dimensional article.

9. The method according to claim 7, wherein at least two different patterns of said surface topography are used in a single three-dimensional article.

10. The method according to claim 1, wherein a hatch direction for fusing said powder material is rotated with respect to the hatch direction for creating said surface topography.

11. The method according to claim 1, further comprising a step of adapting a topography pattern orientation to a powder application direction.

12. The method according to claim 1, wherein said surface topography is created with another energy source than the one for fusing said powder material.

13. The method according to claim 1, wherein said predetermined surface topography defines a chessboard-like pattern, wherein squares defined by said pattern have respective lengths and widths equal to a mean particle size in said powder particle size distribution.

14. The method according to claim 2, wherein said remelting of said first cross section comprises elevating the top surface temperature to a temperature below the melting point in predetermined positions according to a desired pattern, wherein said elevated temperature below said melting temperature is sufficient for softening the surface and amending the surface topography in a localized fashion so as to introduce said desired pattern.

15. A program element configured and arranged when executed on a computer to implement a method for verifying a deflection speed of an energy beam spot, said method comprising the steps of:
generating a model of said three-dimensional article;
applying a first powder layer on a work table;
directing said at least one energy beam from at least one energy beam source over said work table causing said first powder layer to fuse in first selected locations according to said model to form a first cross section of said three-dimensional article; and
generating a predetermined surface topography on said first cross section for at least one of reducing thickness variations or increasing packing density in a powder layer provided on top of said first cross section.

16. A computer readable medium having stored thereon the program element according to claim 15.

17. A non-transitory computer program product comprising at least one computer-readable storage medium having computer-readable program code portions embodied therein, the computer-readable program code portions comprising:
an executable portion configured for directing said at least one energy beam from at least one energy beam source over a work table so as to cause a first powder layer to fuse in first selected locations according to a model of said three-dimensional article, so as to form a first cross section of said three-dimensional article; and
an executable portion configured for generating a predetermined surface topography on said first cross section for at least one of reducing thickness variations or increasing packing density in a powder layer provided on top of said first cross section.

18. The non-transitory computer program product of claim 17, further comprising:
an executable portion configured for generating said model of said three-dimensional article; and
an executable portion configured for applying said first powder layer on said work table.
